(19) United States
(12) Patent Application Publication
(10) Pub. No.: US 2009/0056211 A1
(43) Pub. Date: Mar. 5, 2009

(54) WEARABLE FLORAL DISPLAY DEVICE AND METHOD

(76) Inventors: Lyudmila Mirakyan, Burbank, CA (US); Armine Ardaryan, Glendale, CA (US)

Correspondence Address: ITALIA IP, 3500 WEST OLIVE AVE., SUITE 300, BURBANK, CA, 91505, US

(21) Appl. No.: 11/849,362

(22) Filed: Sep. 4, 2007

(51) Int. Cl. A01G 5/00; A45F 5/08

(52) U.S. Cl. 47/41.01; 24/5

(57) ABSTRACT

A wearable floral display device such as a corsage for displaying a decorative item such as a flower that includes a wire through at least a portion of the decorative item and wherein the device includes a penetrateable member for receiving at least a portion of the wire attached to the decorative member, a strap to attach the device to the wearer, and a protective member for attachment to the lower surface of the penetrateable member, wherein a portion of the wire will be located between the protective member and the lower surface of the penetrateable member when the decorative item is attached to the device.

### BACKGROUND OF INVENTION

This application relates generally to corsages worn by attendees at weddings, dances, or any other occasions where such items are worn. More specifically, this application relates to a wearable floral display device and a method of making such devices, which can be used in conjunction with decorative items such as flowers to generate corsages that can be worn on a user's wrist.

### SUMMARY

The making of corsages is a tedious and time-consuming task for florists. Described herein is a wearable floral display device that can be utilized by florists to make this task much simpler and more cost effective. This application discloses wearable floral display devices that are generated from non-perishable items that when used in conjunction with decorative items, such as flowers (perishable or non-perishable), results in a corsage that is easy to assemble, attaches to the wrist of the user (or any other body part), maintains its shape, and resembles that of a traditional corsage. The device is of simple construction and can be used anywhere it is desirable to generate a corsage with the above mentioned benefits.

In particular, this application discloses a wearable floral display device for displaying a decorative item that includes a wire through at least a portion of said item, said device comprising: a penetrateable member for receiving at least a portion of the wire, wherein said penetrateable member includes an upper and lower surface; strap means attachable to said penetrateable member; and, a protective member for attachment to said lower surface of said penetrateable member, wherein a portion of said wire will be located between said protective member and said lower surface of said penetrateable member when the decorative item is attached to the device.

This application also discloses a wearable floral display device for displaying a decorative item that includes a wire through at least a portion of said item, said device comprising: a penetrateable member for receiving at least a portion of the wire, wherein said penetrateable member includes an upper and lower surface; strap means attachable to said penetrateable member; a protective member for attachment to said lower surface of said penetrateable member wherein a portion of said wire is located between said protective member and said lower surface of said penetrateable member; and, a garnish portion integral with said penetrateable member.

This application further discloses a method of creating a corsage for displaying a decorative item, the method comprising the steps of: utilizing a wearable floral display device comprising a penetrateable member for receiving at least a portion of the wire, wherein said penetrateable member includes an upper and lower surface, and strap means attachable to said penetrateable member; attaching a wire through at least a portion of the decorative item; penetrating the penetrateable member with a portion of the wire; expanding the portion of the wire that penetrated through the penetrateable member such that it is substantially adjacent to said lower surface of said penetrateable member; attaching a protective member to said lower surface to contain said expanded wire portion between said lower penetrateable surface and said protective member.

### BRIEF DESCRIPTION OF THE DRAWINGS

The drawings, when considered in connection with the following description, are presented for the purpose of facilitating an understanding of the subject matter sought to be protected.

FIG. 1 is a perspective view of a first embodiment of the wearable floral display device disclosed herein and a decorative item attached to a wire;

FIG. 2 is a perspective view of the device in FIG. 1 showing the decorative item secured thereto and a first embodiment of the strap means;

FIG. 3 is a perspective view similar to the device in FIG. 2 showing a second embodiment of the strap means;

FIG. 4 is a perspective view similar to the device in FIG. 2 showing a third embodiment of the strap means;

FIG. 5 is a perspective view of a second embodiment of the wearable floral display device disclosed herein and a decorative item attached to a wire;

FIG. 6 is a perspective view of the device in FIG. 5 shown assembled with the decorative item;

FIG. 7 is a perspective opposite view of the device and decorative item in FIG. 5; and,

FIG. 8 is a perspective opposite view of the device shown assembled with the decorative item in FIG. 6.

### DETAILED DESCRIPTION

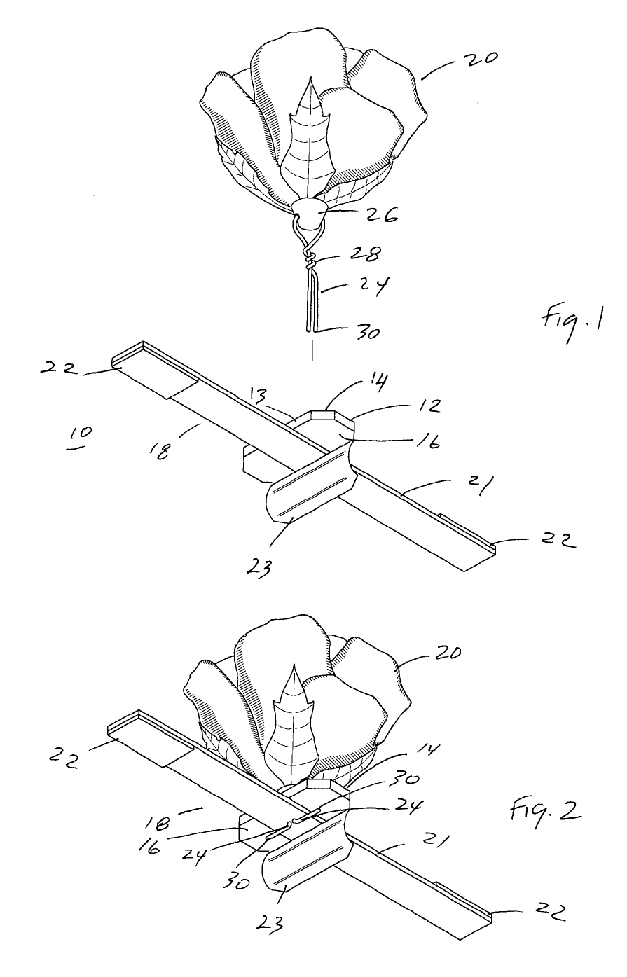

FIG. 1 shows a first embodiment of the wearable floral display device 10 of the present invention. The device 10 includes a penetrateable member 12, wherein the penetrateable member 12 includes an upper 14 and lower surface 16 and is preferably made of foam or similar material. Attached to the penetrateable member 12 is a first embodiment 18 of the strap means which may be attached by glue, latex or any other suitable adhesive. In this embodiment, a strap 21 of flexible material is shown and includes fastener portions 22 on each end to secure the device 10 to the wearer. Potential fasteners usable in this invention include a button, Velcro, snap, fastenable pin, hook and loop assembly, and any other fastener type conventional in the art. In the strap means embodiment described above, and those to be described below, the strap is attached to lower surface 16 of the penetrateable member 12, however, it is contemplated that the strap means may be integral to the surface of the penetrateable member or attached to the sides 13 of the penetrateable member 12. The device 10 also includes a protective member 23 for attachment to the lower surface 16 of the penetrateable member 12.

The device 10 may be used in conjunction with a decorative item 20 such as a flower, leaf, fruit or any other item that the user desires to attach to the device 10. To attach the decorative item 20 to the device 10, a substantially bendable wire is 24 attached to at least a portion of the item 20. Preferably, for a flower, the wire 24 is inserted through the base or bud portion 26 and twisted 28 to maintain in place. With a flower, attachment of the wire 24 to the base or bud portion 26 is preferred as that area of the flower generally has the most structural integrity to support the flower and allows the wire 24 to remain hidden when the item 20 is attached to the device 10.

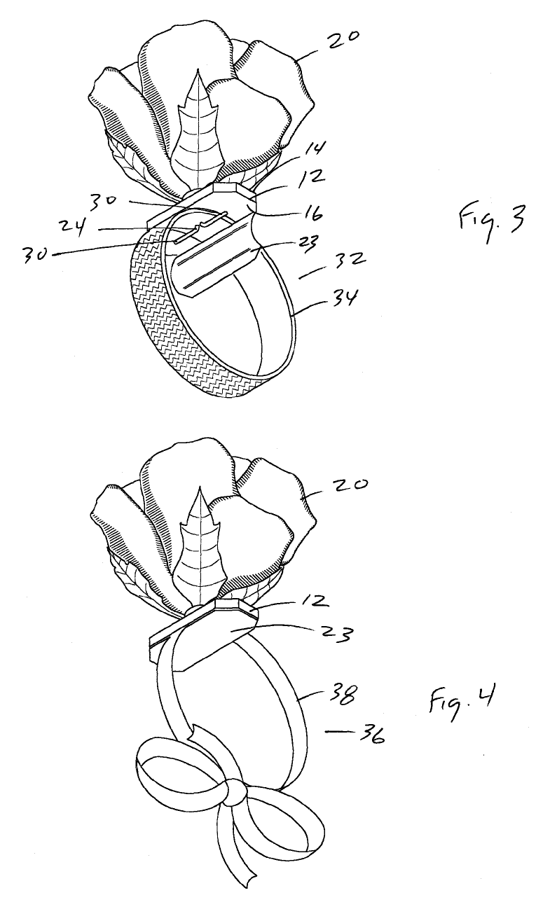

Referring now to FIG. 2, the decorative item 20 is shown secured to the device 10. To attach the item 20 to the device 10, the loose ends 30 of the wire 24 are penetrated through the upper surface 14 of the penetrateable member 12, through the lower surface 16 of the penetrateable member, and in the embodiment shown, through the strap 21. Once through, the loose ends 30 of the wire are expanded such they are substantially adjacent to said lower surface 16 of the penetrateable member, and in the embodiment shown, the strap 21. Finally, the protective member 23 is attached to the lower surface 16 of the penetrateable member 12 to contain the expanded wire loose end portions 30 between the lower surface 16 of the penetrateable member 12 (and in the embodiment shown, the strap 21) and the protective member 23. See FIG. 4 for an example of the protective member 23 attached to the lower surface 16 of the penetrateable member 12. Attachment of the protective member 23 to the penetrateable member 12 can be accomplished with glue, latex or any other suitable adhesive.

Referring now to FIG. 3, a second embodiment 32 of the strap means is shown. In this embodiment a continuous loop 34 of an elastic material is attached to the penetrateable member 12.

Referring now to FIG. 4, a third embodiment 36 of the strap means is shown. In this embodiment a ribbon 38 which can be secured to the wearer by tying the ends together is attached to the penetrateable member 12.

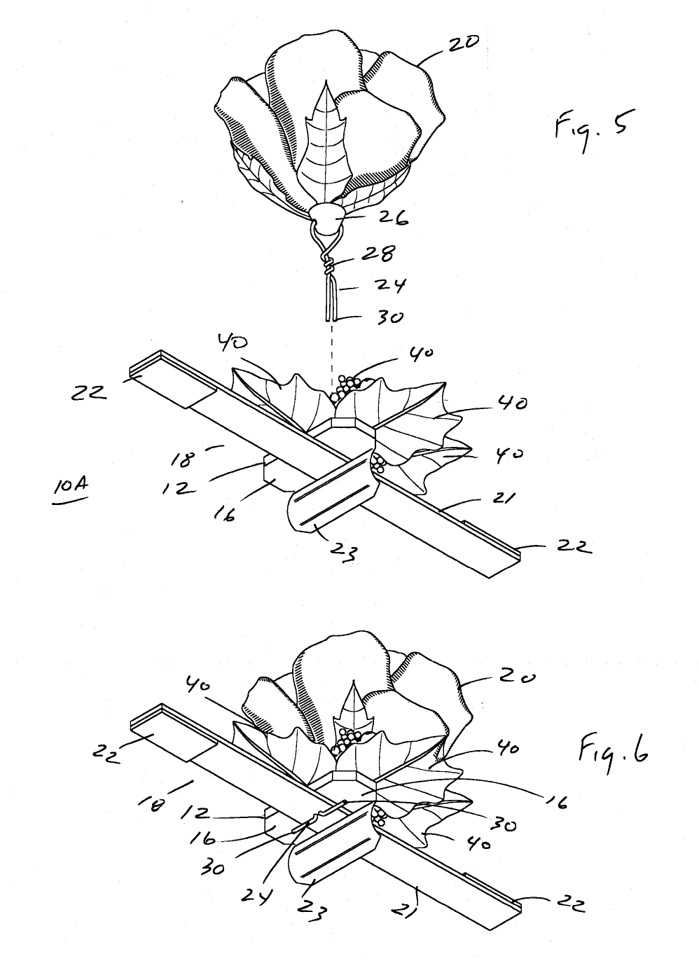

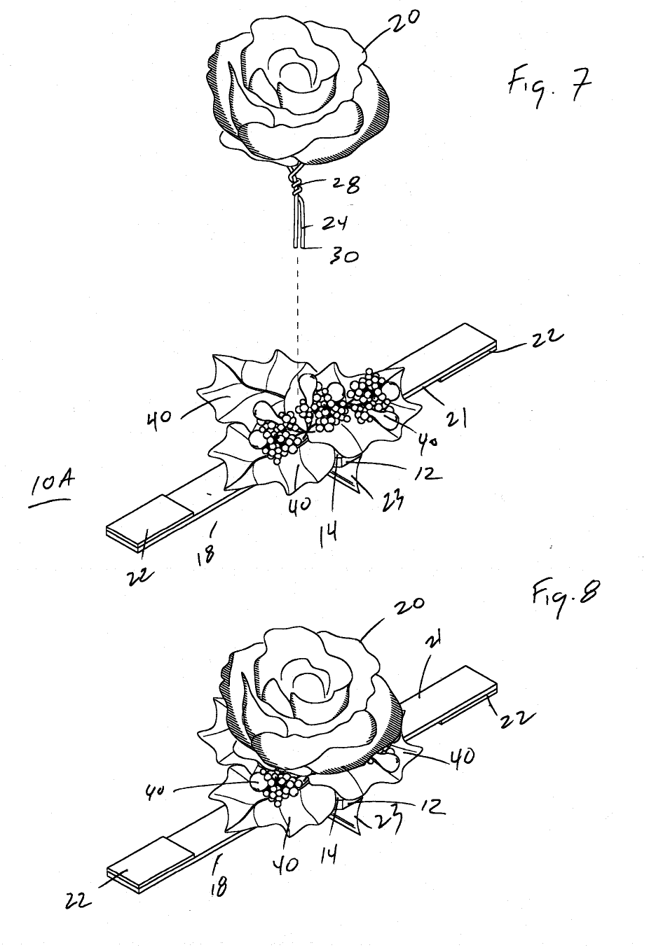

Finally, referring to FIGS. 5-8 a second embodiment of the display device 10A of the present invention is shown. In this embodiment, the upper surface 14 of the penetrateable member 12 includes a non-perishable garnish portion 40 that may either be attached to the stem portion via an adhesive, molded thereto, and/or attached in the same way as described for the decorative item above. As shown, the garnish portion 40 may include leaves, berries, or any other item that would be desired in the final arrangement. The second embodiment of the display device 10A can utilized with each of the strap means described above.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A wearable floral display device for displaying a decorative item that includes a wire through at least a portion of said item, said device comprising:
a penetrateable member for receiving at least a portion of the wire, wherein said penetrateable member includes an upper and lower surface;
strap means attachable to said penetrateable member; and,
a protective member for attachment to said lower surface of said penetrateable member, wherein a portion of said wire will be located between said protective member and said lower surface of said penetrateable member when the decorative item is attached to the device.

2. The device of claim 1 wherein the strap means is attached to the lower surface of the penetrateable member and wherein a portion of the wire will be located between said protective member and said strap means when the decorative item is attached to the device.

3. The device of claim 2 wherein the strap means is a strap of flexible material that is secured by fastener selected from the group consisting of button, Velcro, snap, fastenable pin, and hook and loop.

4. The device of claim 2 wherein the strap means is a continuous loop of an elastic material.

5. The device of claim 2 wherein the strap means is a ribbon material that is secured by tying the ends together.

6. The device of claim 1 wherein the strap means is a strap of flexible material that is secured by fastener selected from the group consisting of button, Velcro, snap, fastenable pin, and hook and loop.

7. The device of claim 1 wherein the strap means is a continuous loop of an elastic material.

8. The device of claim 1 wherein the strap means is a ribbon material that is secured by tying the ends together.

9. A wearable floral display device for displaying a decorative item that includes a wire through at least a portion of said item, said device comprising:
a penetrateable member for receiving at least a portion of the wire, wherein said penetrateable member includes an upper and lower surface;
strap means attachable to said penetrateable member;
a protective member for attachment to said lower surface of said penetrateable member wherein a portion of said wire is located between said protective member and said lower surface of said penetrateable member; and,
a garnish portion integral with said penetrateable member.

10. The device of claim 9 wherein the garnish portion is attached to the upper surface of the penetrateable member with an adhesive.

11. The device of claim 10 wherein the strap means is a strap of flexible material that is secured by fastener selected from the group consisting of button, Velcro, snap, fastenable pin, and hook and loop.

12. The device of claim 10 wherein the strap means is a continuous loop of an elastic material.

13. The device of claim 10 wherein the strap means is a ribbon material that is secured by tying the ends together.

14. The device of claim 9 wherein the strap means is a strap of flexible material that is secured by fastener selected from the group consisting of button, Velcro, snap, fastenable pin, and hook and loop.

15. The device of claim 9 wherein the strap means is a continuous loop of an elastic material.

16. The device of claim 9 wherein the strap means is a ribbon material that is secured by tying the ends together.

17. A method of creating a corsage for displaying a decorative item, the method comprising the steps of:
utilizing a wearable floral display device comprising a penetrateable member for receiving at least a portion of the wire, wherein said penetrateable member includes an upper and lower surface, and strap means attachable to said penetrateable member;
attaching a wire through at least a portion of the decorative item;
penetrating the penetrateable member with a portion of the wire;
expanding the portion of the wire that penetrated through the penetrateable member such that it is substantially adjacent to said lower surface of said penetrateable member;
attaching a protective member to said lower surface to contain said expanded wire portion between said lower penetrateable surface and said protective member.

18. The device of claim 17 wherein the strap means is a strap of flexible material that is secured by fastener selected from the group consisting of button, Velcro, snap, fastenable pin, and hook and loop.

19. The device of claim 17 wherein the strap means is a continuous loop of an elastic material.

20. The device of claim 17 wherein the strap means is a ribbon material that is secured by tying the ends together.
